(19) United States
(12) Patent Application Publication
(10) Pub. No.: US 2025/0334337 A1
(43) Pub. Date: Oct. 30, 2025

(54) HYDROGEN DECREPITATION FURNACE CAPABLE OF FEEDING AND DISCHARGING MATERIALS EASILY

(71) Applicant: Baiqida Intelligent Technology (Ningbo) Co., Ltd., Ningbo (CN)

(72) Inventors: Keqi Zheng, Ningbo (CN); Yueming Huang, Ningbo (CN); Huihe Fang, Ningbo (CN); Xingjie Wang, Ningbo (CN); Niansheng Zhou, Ningbo (CN); Xiongpeng Zhu, Ningbo (CN); Hao Zhu, Ningbo (CN); Kaixuan Yu, Ningbo (CN); Lei Zhang, Ningbo (CN); Jian Cao, Ningbo (CN); Kai Xu, Ningbo (CN); Jianfeng Xin, Ningbo (CN)

(21) Appl. No.: 18/818,676

(22) Filed: Aug. 29, 2024

(30) Foreign Application Priority Data
Apr. 28, 2024 (CN) 2024209056054

(51) Int. Cl. F27D 11/00; F27D 3/00; F27D 9/00

(52) U.S. Cl. CPC F27D 11/00; F27D 2003/0038; F27D 2003/0089; F27D 2009/0016

(57) ABSTRACT

A hydrogen decrepitating furnace for shortening of feeding and discharging time capable of feeding and discharging materials easily comprises a main frame, a heating furnace, electric furnace stands and electric furnaces, wherein the heating furnace and a driving mechanism for driving the electric furnaces to rotate are arranged on the main frame, the heating furnace is provided with a feed and discharge port and a valve for opening or closing the feed and discharge port, a gas control device is connected to a side corresponding to the feed and discharge port of the heating furnace, the lifting mechanism is able to lift the heating furnace to allow materials to be easily discharged from the hydrogen decrepitation furnace, the electric furnaces are correspondingly arranged on the electric furnace stands, and moving mechanisms for driving the electric furnaces to be opened or closed are arranged on the two electric furnace stands.

### BACKGROUND OF THE INVENTION

### 1. Technical Field

The invention relates to the technical field of hydrogen decrepitation furnaces, and particularly relates to a hydrogen decrepitation furnace capable of feeding and discharging materials easily.

### 2. Description of Related Art

Hydrogen decrepitation furnaces, as equipment for processing neodymium-iron-boron alloy materials, can pulverize alloys by means of inter-granular fracture and trans-granular fracture generated by rare earth permanent-magnet alloys during the hydrogenation and dehydrogenation process to obtain alloy powder with a certain granularity. Neodymium-iron-boron ingots processed by the hydrogen decrepitation furnaces can directly enter the next process (jet-milling), such that the probability of oxidization of materials is effectively reduced.

According to existing hydrogen decrepitation furnaces, a feed pipe and a discharge pipe are arranged at two ends of a cylinder respectively, for example, the hydrogen decrepitation furnace for hydrogenating rare earth alloys disclosed by Chinese Patent (Application No. 201020613042.X). However, the hydrogen decrepitation furnace has a large overall size, thus occupying a large space; in addition, the hydrogen decrepitation furnace has too many openings, so leaking occurs easily, and oxygen is likely to enter the hydrogen decrepitation furnace from the outside. In view of this, those skilled in the art propose the design of arranging a feed end and a discharge end of the hydrogen decrepitation furnace on a same side of the hydrogen decrepitation furnace, for example, the main structure of a hydrogen decrepitation furnace disclosed by Chinse Patent (Application and Publication No. CN113560584B). However, feeding and discharging of existing hydrogen decrepitation furnaces are still inconvenient, so further improvements are necessary.

### BRIEF SUMMARY OF THE INVENTION

The purpose of the invention is to provide a hydrogen decrepitation furnace capable of feeding and discharging materials easily. A heating furnace of the hydrogen decrepitation furnace is designed into a structure inclining downwards from a feed and discharge port to the other side, such that materials can be directly fed to the feed and discharge port of the heating furnace; in addition, the side away from the feed and discharge port of the heating furnace can be lifted only by means of a lifting mechanism, such that materials can be easily discharged from the hydrogen decrepitation furnace.

The above technical purpose of the invention is fulfilled by means of the following technical solution: a hydrogen decrepitation furnace capable of feeding and discharging materials easily comprises a main frame, a heating furnace, electric furnace stands and electric furnaces, wherein the heating furnace and a driving mechanism for driving the electric furnaces to rotate are arranged on the main frame, a left side of the main frame is higher than a right side of the main frame to allow the heating furnace to incline upward from right to left, the heating furnace is provided with a feed and discharge port and a valve for opening or closing the feed and discharge port, a gas control device is connected to a side corresponding to the feed and discharge port of the heating furnace, the feed and discharge port is arranged in the left side of the main frame, a lifting mechanism for lifting a right side of the heating furnace is arranged on the right side of the main frame, the lifting mechanism is able to lift the heating furnace to allow materials to be easily discharged from the hydrogen decrepitation furnace, the electric furnace stands are arranged on two sides of the main frame and have an inclination angle matching an inclination angle of the main frame, the electric furnaces are correspondingly arranged on the electric furnace stands, and moving mechanisms for driving the electric furnaces to be opened or closed are arranged on the two electric furnace stands.

Further, a cooling device is arranged at a bottom of the main frame, has an inclination angle matching the inclination angle of the main frame, and comprises a water tank and a lifting mechanism for driving the water tank to ascend or descend, and a spraying mechanism and a return water circulation mechanism are arranged in the water tank.

Further, the main frame comprises a base and a rack, the base inclines upward from right to left, the rack is arranged on the base and has a left end hinged to the base, the electric furnaces are rotatably mounted on the rack, a lower end of the lifting mechanism is hinged to the base, an output end of the lifting mechanism is hinged to the rack, and when the lifting mechanism lifts the heating furnace, the rack is driven to rotate with a hinge end of the rack as a pivot.

Further, the gas control device is connected to a pipe opening in the side corresponding to the feed and discharge port of the heating furnace by means of a pipeline, and gas in the heating furnace is controlled by means of the gas control device.

Further, a fixing frame and a feeding device arranged on the fixing frame are arranged on a left side of the hydrogen decrepitation furnace, and the feeding device is able to reciprocate in an inclination direction of the main frame to allow a spiral feed pipe of the feeding device to be connected to or disconnected from the feed and discharge port of the heating furnace.

Further, a fixing frame and a feeding device arranged on the fixing frame are arranged on a left side of the hydrogen decrepitation furnace, the feeding device comprises a feed trolley, a feed pipe connected to the feed trolley, and a vibratory feeder for feeding materials stably, and the feeding device is able to reciprocate in an inclination direction of the main frame to allow the feed pipe of the feeding device to be connected to or disconnected from the feed and discharge port of the heating furnace.

Further, a feeding platform is arranged on the fixing frame, and materials are fed into the feed trolley of the feeding device by means of the feeding platform.

Further, the inclination angle of the main frame is A, wherein 10°≤A≤40°.

To sum up, the invention has the following beneficial effects:

According to the hydrogen decrepitation furnace provided by the invention, the heating furnace is designed into a structure inclining from the feed and discharge port to the other side, such that materials can be directly fed to the feed and discharge port of the heating furnace; moreover, the side away from the feed and discharge port of the heating can be lifted only by means of the lifting mechanism, such that materials can be easily discharged from the hydrogen decrepitation furnace, thus greatly shortening the feeding and discharging time.

### BRIEF DESCRIPTION OF THE SEVERAL VIEWS OF THE DRAWINGS

FIG. 1 is a front view of the invention.

FIG. 2 is a schematic structural view of a feeding device and a hydrogen decrepitation furnace from a first perspective according to the invention.

FIG. 3 is a schematic structural view of the hydrogen decrepitation furnace according to the invention.

FIG. 4 is a top view of the invention.

FIG. 5 is a schematic structural view of the feeding device and the hydrogen decrepitation furnace from a second perspective according to the invention.

FIG. 6 is a schematic structural view of the feeding device and the hydrogen decrepitation furnace from a third perspective according to the invention.

In the FIGS.: 10, main frame; 11, base; 12, rack; 20, heating furnace; 21, feed and discharge port; 30, electric furnace stand; 40, electric furnace; 50, gas control device; 60, lifting mechanism; 70, cooling device; 71, water tank; 72, lifting mechanism; 80, fixing frame; 81, feeding device; 82, feeding platform.

### DETAILED DESCRIPTION OF THE INVENTION

The invention is further described below in conjunction with accompanying drawings.

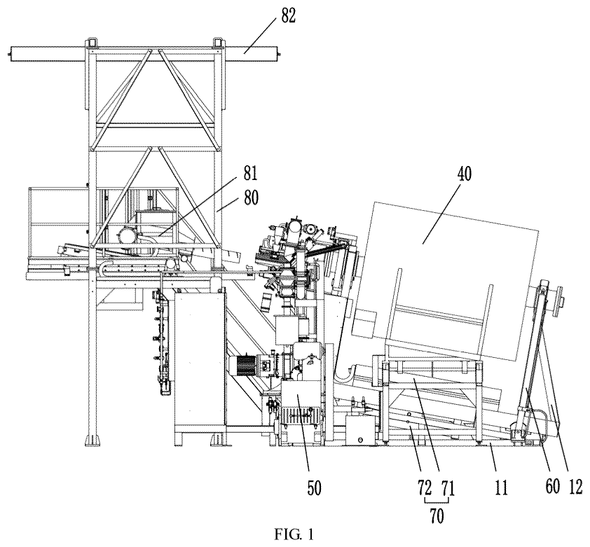

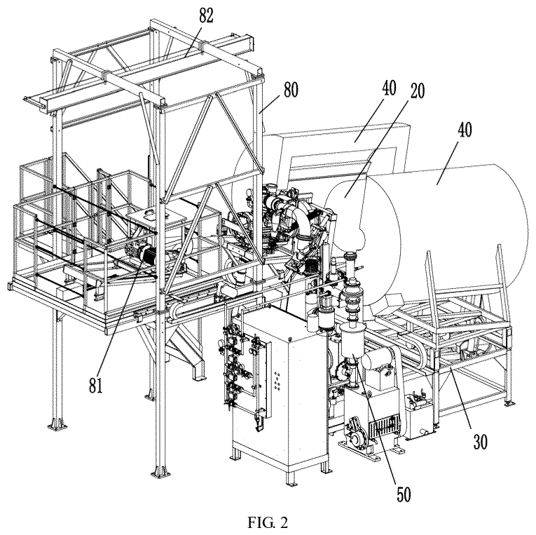

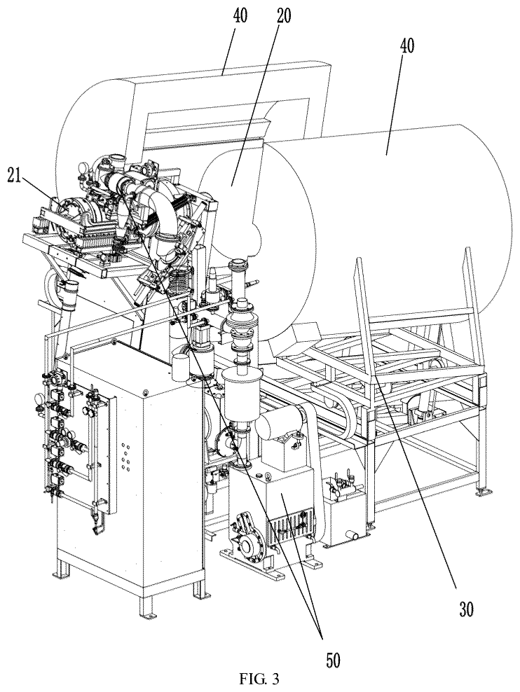

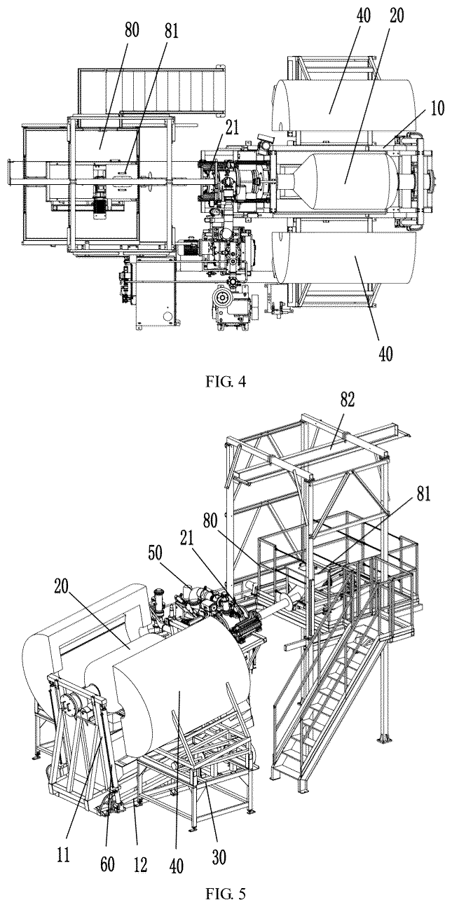

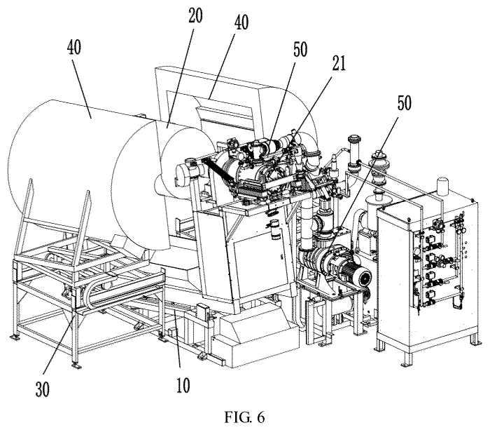

As shown in FIGS. 1-6, a hydrogen decrepitation furnace capable of feeding and discharging materials easily comprises a main frame 10, a heating furnace 20, electric furnace stands 30 and electric furnaces 40, wherein the heating furnace 20 and a driving mechanism for driving the electric furnaces 40 to rotate are arranged on the main frame 10, and a left side of the main frame 10 is higher than a right side of the main frame 10 to allow the heating furnace 20 to incline upward from right to left. Further, the main frame 10 comprises a base 11 and a rack 12, the base 11 inclines upward from right to left, the rack 12 is arranged on the base 11 and has a left end hinged to the base 11, and the electric furnaces 40 are rotatably mounted on the rack 12. In the invention, an inclination angle of the main frame 10 is A, that is, an inclination angle of the electric furnaces 40 in the initial state is A, wherein 10°≤A≤40°, and preferably A is 15°.

The heating furnace 20 is provided with a feed and discharge port 21 and a valve for opening or closing the feed and discharge port 21, that is to say, the feed and discharge port 21 of the heating furnace 20 in the invention functions as both a feed port and a discharge port, and a gas control device 50 is connected to a side corresponding to the feed and discharge port 21 of the heating furnace 20. Further, the gas control device 50 is connected to a pipe opening in the side corresponding to the feed and discharge port 21 of the heating furnace 20 by means of a pipeline, and gas in the heating furnace 20 is controlled by means of the gas control device 50, for example, vacuumizing, oxygen discharging and hydrogen injection may be performed on the heating furnace 20 by means of the gas control device 50.

The feed and discharge port 21 of the heating furnace 20 is arranged in the left side of the main frame 10, a lifting mechanism 60 for lifting a right side of the heating furnace 20 is arranged on the right side of the main frame 10, and the lifting mechanism 60 is able to lift the heating furnace 20 to allow materials to be easily discharged from the hydrogen decrepitation furnace. Specifically, a lower end of the lifting mechanism 60 is hinged to the base 11, an output end of the lifting mechanism 60 is hinged to the rack 12, and when the lifting mechanism 60 lifts the heating furnace 20, the rack 12 is driven to rotate with a hinge end of the rack 12 as a pivot. In the invention, the lifting mechanism 60 comprises two oil cylinders, which are arranged on two sides of the rack 12 respectively.

The electric furnace stands 30 are arranged on two sides of the main frame 10 and have an inclination angle matching the inclination angle of the main frame 10, the electric furnaces 40 are correspondingly arranged on the electric furnace stands 30, moving mechanisms for driving the electric furnaces 40 to be opened or closed are arranged on the two electric furnace stands 30, the electric furnaces 40 on left and right sides are configured as semi-cylindrical structures respectively, and the moving mechanisms are able to drive the electric furnaces 40 to move horizontally with respect to the electric furnace stands 30 to control the two electric furnaces 40 to be opened or closed.

A cooling device 70 is arranged at the bottom of the main frame 10, has an inclination angle matching the inclination angle of the main frame 10, and comprises a water tank 71 and a lifting mechanism 72 for driving the water tank 71 to ascend or descend, a spraying mechanism and a return water circulation mechanism are arranged in the water tank 71, the water tank 71 is used for containing cooling water, the cooling water is sprayed by the spraying mechanism to the heating furnace 20 to cooling the heating furnace 20, and the return water circulation mechanism is used for circulating the cooling water.

A fixing frame 80 and a feeding device 81 arranged on the fixing frame 80 are arranged on a left side of the hydrogen decrepitation furnace. Embodiment 1 of the feeding device 81: the feeding device 81 is able to reciprocate in an inclination direction of the main frame 10 to allow a spiral feed pipe of the feeding device 81 to be connected to or disconnected from the feed and discharge port 21 of the heating furnace 20, and details of the feeding device 81 can be understood with reference to the feeding device for a hydrogen decrepitation furnace disclosed by Chinese Patent (Application and Publication No. CN218786385U). Embodiment 2 of the feeding device 81: a fixing frame 80 and a feeding device 81 arranged on the fixing frame 80 are arranged on a left side of the hydrogen decrepitation furnace, the feeding device 81 comprises a feed trolley, a feed pipe connected to the feed trolley, and a vibratory feeder for feeding materials stably, and the feeding device 81 is able to reciprocate in an inclination direction of the main frame 10 to allow the feed pipe of the feeding device 81 to be connected to or disconnected from the feed and discharge port 21 of the heating furnace 20.

Further, a feeding platform 82 is arranged on the fixing frame 80, materials are fed into the feed trolley of the feeding device 81 by means of the feeding platform 82, and the feeding platform 82 is arranged at a top end of the fixing frame 80 and may be an electric hoist.

To sum up, the invention has the following beneficial effects:

According to the hydrogen decrepitation furnace provided by the invention, the heating furnace 20 is designed into a structure inclining from the feed and discharge port 21 to the other side, such that materials can be directly fed to the feed and discharge port 21 of the heating furnace 20; moreover, the side away from the feed and discharge port 21 of the heating 20 can be lifted only by means of the lifting mechanism 60, such that materials can be easily discharged from the hydrogen decrepitation furnace, thus greatly shortening the feeding and discharging time.

The above embodiments are merely preferred ones of the invention, and all equivalent transformations or modifications made according to the structures, features and principles within the patent application range of the invention should fall within the patent application range of the invention.

What is claimed is:

1. A hydrogen decrepitation furnace capable of feeding and discharging materials easily, comprising a main frame (10), a heating furnace (20), electric furnace stands (30) and electric furnaces (40), wherein the heating furnace (20) and a driving mechanism for driving the electric furnaces (40) to rotate are arranged on the main frame (10), a left side of the main frame (10) is higher than a right side of the main frame (10) to allow the heating furnace (20) to incline upward from right to left, the heating furnace (20) is provided with a feed and discharge port (21) and a valve for opening or closing the feed and discharge port (21), a gas control device (50) is connected to a side corresponding to the feed and discharge port (21) of the heating furnace (20), the feed and discharge port (21) is arranged in the left side of the main frame (10), a lifting mechanism (60) for lifting a right side of the heating furnace (20) is arranged on the right side of the main frame (10), the lifting mechanism (60) is able to lift the heating furnace (20) to allow materials to be easily discharged from the hydrogen decrepitation furnace, the electric furnace stands (30) are arranged on two sides of the main frame (10) and have an inclination angle matching an inclination angle of the main frame (10), the electric furnaces (40) are correspondingly arranged on the electric furnace stands (30), and moving mechanisms for driving the electric furnaces (40) to be opened or closed are arranged on the two electric furnace stands (30).

2. The hydrogen decrepitation furnace capable of feeding and discharging materials easily according to claim 1, wherein a cooling device (70) is arranged at a bottom of the main frame (10), has an inclination angle matching the inclination angle of the main frame (10), and comprises a water tank (71) and a lifting mechanism (72) for driving the water tank (71) to ascend or descend, and a spraying mechanism and a return water circulation mechanism are arranged in the water tank (71).

3. The hydrogen decrepitation furnace capable of feeding and discharging materials easily according to claim 1, wherein the main frame (10) comprises a base (11) and a rack (12), the base (11) inclines upward from right to left, the rack (12) is arranged on the base (11) and has a left end hinged to the base (11), the electric furnaces (40) are rotatably mounted on the rack (12), a lower end of the lifting mechanism (60) is hinged to the base (11), an output end of the lifting mechanism (60) is hinged to the rack (12), and when the lifting mechanism (60) lifts the heating furnace (20), the rack (12) is driven to rotate with a hinge end of the rack (12) as a pivot.

4. The hydrogen decrepitation furnace capable of feeding and discharging materials easily according to claim 1, wherein the gas control device (50) is connected to a pipe opening in the side corresponding to the feed and discharge port (21) of the heating furnace (20) by means of a pipeline, and gas in the heating furnace (20) is controlled by means of the gas control device (50).

5. The hydrogen decrepitation furnace capable of feeding and discharging materials easily according to claim 1, wherein a fixing frame (80) and a feeding device (81) arranged on the fixing frame (80) are arranged on a left side of the hydrogen decrepitation furnace, and the feeding device (81) is able to reciprocate in an inclination direction of the main frame (10) to allow a spiral feed pipe of the feeding device (81) to be connected to or disconnected from the feed and discharge port (21) of the heating furnace (20).

6. The hydrogen decrepitation furnace capable of feeding and discharging materials easily according to claim 1, wherein a fixing frame (80) and a feeding device (81) arranged on the fixing frame (80) are arranged on a left side of the hydrogen decrepitation furnace, the feeding device (81) comprises a feed trolley, a feed pipe connected to the feed trolley, and a vibratory feeder for feeding materials stably, and the feeding device (81) is able to reciprocate in an inclination direction of the main frame (10) to allow the feed pipe of the feeding device (81) to be connected to or disconnected from the feed and discharge port (21) of the heating furnace (20).

7. The hydrogen decrepitation furnace capable of feeding and discharging materials easily according to claim 1, wherein a feeding platform (82) is arranged on the fixing frame (8), and materials are fed into the feed trolley of the feeding device (81) by means of the feeding platform (82).

8. The hydrogen decrepitation furnace capable of feeding and discharging materials easily according to any one of claim 1, wherein the inclination angle of the main frame (10) is A, wherein 10°≤A≤40°.
